(19) United States
(12) Patent Application Publication
(10) Pub. No.: US 2007/0073453 A1
(43) Pub. Date: Mar. 29, 2007

(54) System architecture for controlling and monitoring components of a railroad safety installation

(75) Inventors: Andreas Dalnodar, Peine (DE); Matthias Holzmuller, Konigslutter (DE); Blake Kozol, Braunschweig (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/238,111

(22) Filed: Sep. 29, 2005

(51) Int. Cl. G05D 1/00

(52) U.S. Cl. 701/19

(57) ABSTRACT

The invention relates to a system architecture for controlling and monitoring components, in particular light signals, switches, rail circuits, rail junctions, passenger information systems, of a railroad safety installation. In order to improve the availability and the adaptability to changing environmental conditions, the invention provides that an automation platform which comprises a plurality of modules, in particular a CPU, a power supply, a module for safety-relevant signal processing, a module for non-safety-relevant signal processing and a communication module is connected via specific interfaces to safety-relevant and non-safety-relevant components of the railroad safety installation.

### TECHNICAL FIELD OF THE INVENTION

The invention relates to a system architecture for controlling and monitoring components of a railroad safety installation.

### BACKGROUND OF THE INVENTION

Microcomputer-based systems are predominantly used for controlling and monitoring railroad safety installations, in particular signal boxes, whose signaling is designed to be safe. In addition, railroad operators frequently in parallel demand control and monitoring whose signaling is not safe and which are provided either by means of a separate microprocessor system or by means of appropriate extension to the functionality of the existing microprocessor system. These microprocessor systems typically comprise CPUs, power supplies, input and output devices as well as specific interfaces which are matched to the components to be controlled. Because of the large number of very different railroad safety installations with different peripheral components, a large number of application-specific system architectures exist and, in particular, have highly specialized interfaces. The requirements for the system architecture are in some cases specified by Norms and Standards, for example in the USA by AREMA, AAR, IEEE, MIL, FRA, and in some cases result from operator-specific requirements, which are frequently derived from the existing railroad infrastructure. As a result of the very high degree of diversification of the system architectures, which are based on different basic logic, adaptations to changing conditions, for example to components to be newly included in the external installation, are associated with major difficulties. Changes such as these can frequently not be implemented by the railroad operator.

### SUMMARY OF THE INVENTION

The invention discloses a system architecture which allows a high degree of standardization of the basic logic, while improving the availability and simpler adaptability to changing environmental conditions.

According to one embodiment of the invention, there is an automation platform which comprises a plurality of modules, in particular a CPU, a power supply, a module for safety-relevant signal processing, a module for non-safety-relevant signal processing and a communication module is connected via specific interfaces to safety-relevant and non-safety-relevant components of the railroad safety installation. The existing automation platform, for example the SIMATIC platform from Siemens, is a modular system for industrial automation installations, and has not been used until now for railroad control and monitoring. The predetermined software structure of the automation platform is normally organized on a modular or hierarchical basis such that the logistics of the railroad safety installation, in particular the signaling box logistics, can be organized in function-specific software programs. The software for these functions can effectively be reused for very different environmental conditions. This makes it possible for railroad operators to adapt to this basic logic appropriately. The required engineering effort is considerably less than in the case of discrete, highly-specialized systems which have been developed for the specific environmental conditions. Furthermore, greater availability and better performance of the system hardware can be achieved with an existing automation platform, since it can be assumed that the automation platform represents a proven system of a robust nature and with high production margins. In this case, capabilities are frequently configured which can be used highly advantageously for railroad safety installations, require very high investment for the development of specialized systems, and are frequently susceptible to faults. This relates, for example, to remote monitoring, special control principles, modular programming capabilities and fault diagnosis. Furthermore, consistent automation on the basis of microprocessor-based systems is advantageous, so that there is no need for electromechanical and, in particular, relay-based mechanisms, which conventionally require a high degree of maintenance effort.

According to one aspect of the invention, the CPU in the automation platform should be able to store programs for safety-relevant applications and for non-safety-relevant applications. There is therefore no need for splitting into two different systems, that is to say for safe applications and for non-safe applications. Safe and non-safe programs can be separated in a simple manner on the basis of memory space, so that it is possible to preclude non-safe programs having any influence on safe programs.

The automation platform that is used should, according to another aspect of the invention, have device for component-specific fault diagnosis. Until now, problems when faults occur have been solved by switching off all the system components completely. The component-specific fault diagnosis results in simple localization of the fault, so that only those system components in which a fault has occurred need be switched off. Furthermore, the improved fault localization in conjunction with scaleable hierarchical reactions allows categorization to be carried out, which in the end allows a very practical fault management and fault reaction.

A communication module which is normally available in the automation platform can also advantageously be used for railroad safety installations. According to claim still another aspect of the invention, the communication module is connected to a control center for bidirectional data transmission, in particular for control, monitoring and fault diagnosis, via at least one communication network, in particular by radio and/or by a landline network. This simplifies the normal complexity for control and monitoring. For example, fault messages can be analyzed and processed by remote diagnosis, and there is frequently no need for on-site expert assessment of components, in particular of field elements such as light signals, switches, rail circuits or rail junctions.

The automation platform that is used should, according to still another aspect of the invention, have a module for safety-relevant signal processing, which additionally has component-specific functional units, in particular rail circuit functional units, which offers the capability to carry out tasks for component-specific functional units, in particular rail circuit functional units, in addition to the signal processing. The integration of rail-circuit-specific assemblies makes it possible to combine two intrinsically different systems, specifically a rail circuit and a signaling box, in a single modular platform.

### BRIEF DESCRIPTION OF THE DRAWINGS

The invention will be explained in more detail in the following text with reference to an exemplary embodiment which is illustrated in the drawing.

FIG. 1 shows a block diagram illustrating the use of an automation platform for a railroad safety installation.

### DETAILED DESCRIPTION OF THE INVENTION

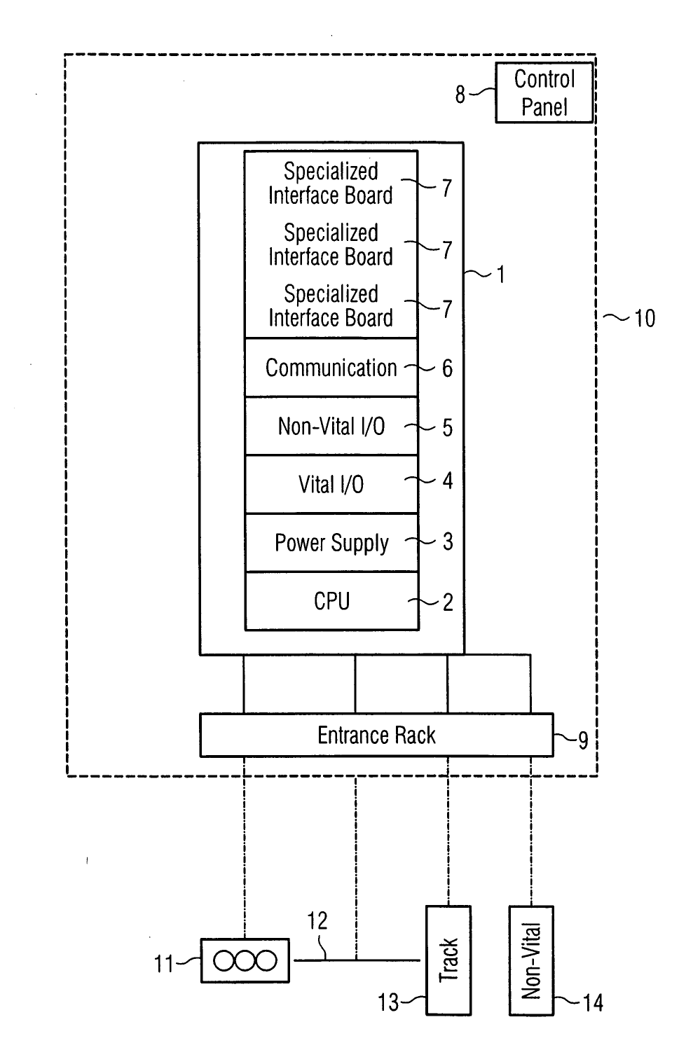

FIG. 1 shows a block diagram, illustrating the use of an automation platform for a railroad safety installation. The automation platform 1 in this case essentially comprises a CPU 2, a power supply 3, a module for safety-relevant signal processing 4, a module for non-safety-relevant signal processing 5, and a communication module 6. These modules 2 to 6 in their own right offer significant basic functions for control and monitoring of components of the railroad safety installation, in which case necessary adaptations are possible relatively easily by means of the modular configuration. The appropriately adapted modules 2 to 6 as well as further interfaces 7 together with a control panel 8 and appropriate connections 9 for components of the external installation form the major functional units of a signal box 10. The connections 9 are connected to the components of the railroad safety installation to be controlled and to be monitored, with the figure illustrating, by way of example, a signal 11, a switch 12, a rail circuit 13 and a non-safety-relevant component 14, for example a passenger information system 14.

1. A system architecture for controlling and monitoring components, comprising an automation platform which includes a plurality of modules connected via specific interfaces to safety-relevant and non-safety-relevant components of the railroad safety installation.

2. The system architecture as claimed in claim 1,
wherein the automation platform has a CPU which has program memory for safety-relevant and non-safety-relevant applications.

3. The system architecture as claimed in claim 1, wherein the automation platform has a device for component-specific fault diagnosis.

4. The system architecture as claimed in claim 1, wherein the automation platform has a communication modules which is connected to a control center for bidirectional data transmission via at least one communication network

5. The system architecture as claimed in claim 1 wherein the automation platform has a module for safety-relevant signal processing, which additionally has component-specific functional units.

6. The system architecture for controlling and monitoring components, wherein
the components include at least one of light signals, switches, rail circuits, rail junctions, passenger information systems, and
the plurality of modules includes at least one of a CPU, a power supply, a module for safety-relevant signal processing, a module for non-safety-relevant signal processing and a communication module.
